(19) United States
(12) Patent Application Publication
(10) Pub. No.: US 2023/0062730 A1
(43) Pub. Date: Mar. 2, 2023

(54) ACRYLIC AND MODACRYLIC FIBER STABILIZED AGAINST SUNLIGHT

(71) Applicant: AKSA AKRILIK KIMYA SANAYII ANONIM SIRKETI, Çiftlikköy, Yalova (TR)

(72) Inventor: Meryem Seyma AYKAN, Istanbul (TR)

(21) Appl. No.: 17/759,935

(22) PCT Filed: Feb. 1, 2021
(86) PCT No.: PCT/TR2021/050094

§ 371 Date: Aug. 2, 2022

(30) Foreign Application Priority Data
Feb. 3, 2020 (TR) 2020/01552

(51) Int. Cl. C08F 220/44; C08F 214/10; C08K 5/3492; C08K 3/22; C08K 5/07

(52) U.S. Cl. CPC C08F 220/44; C08F 214/10; C08K 5/34926; C08K 3/22; C08K 5/07; C08K 2003/2213; C08K 2003/2296; C08K 2003/2255; C08K 2003/2244; C08K 2003/328

(57) ABSTRACT

Acrylic and modacrylic fiber stabilized against sunlight The invention is related to increasing the resistance of acrylic fiber containing at least 85% acrylonitrile groups and modacrylic fibers containing at least 40% acrylonitrile groups and at least 40% vinylidene chloride groups, against UV light and surface heating caused by sunlight.

### TECHNICAL FIELD

The invention is related to increasing the resistance against UV light and surface heating caused by sunlight, of acrylic fiber containing at least 85% acrylonitrile groups, or modacrylic fibers containing at least 40% acrylonitrile groups and at least 40% vinylidene chloride groups, that are produced to be used in outdoor textiles.

### PRIOR ART

Acrylonitrile, which is a widely used monomer during the synthesis of various organic products such as acrylic fiber, resin and plastics, is a highly reactive compound containing an active vinyl and cyanide group. The widely used area of acrylonitrile is the production of acrylic and modacrylic fibers, and acrylic fibers contain co-monomers. Fibers with acrylonitrile ratio of 85% and more by weight, are called acrylic and those between 35-85% are called modacrylic. Due to their resemblance to wool and their hydrophobic properties, acrylic and modacrylic fibers can be used in a wide range of textiles. Especially when used outdoors, problems such as color change and loss of strength are experienced over time. The main reason for that is UV and Infrared radiation received from sunlight destroy the structure of the polymers. In the prior art, HALS (hindered amine light stabilizer) or UV absorbers are used in acrylic and modacrylic fibers to protect them against sunlight.

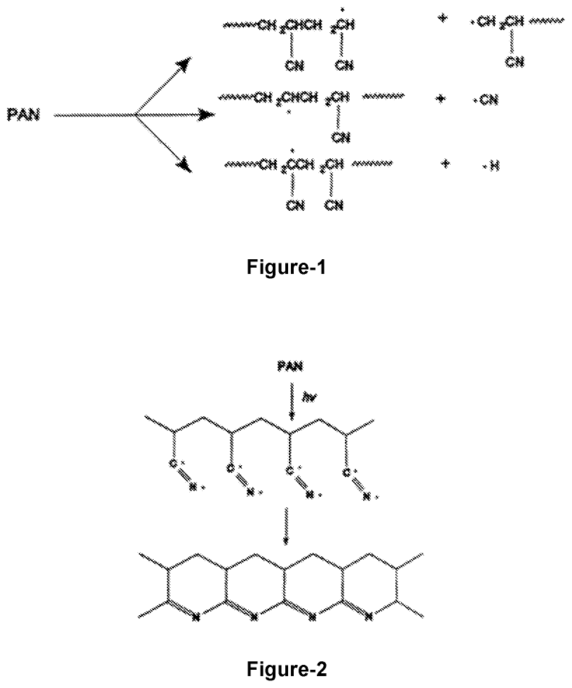

The degradation mechanism of acrylic fiber against light and heat is different from each other and two types of degradation are observed when acrylic fiber is exposed to sunlight. The light degradation mechanism of acrylic fiber is given in FIG. 1, and the heat degradation mechanism of acrylic fiber is given in FIG. 2. According to the degradation mechanism of acrylic fiber against light, harmful primary radicals are formed when acrylic fiber is exposed to UV wavelengths. HALS structures are known to render these primary radicals harmless. In case of degradation against heat, HALS stabilizers cannot prevent this degradation. UV absorbers absorb harmful UV wavelengths from sunlight and reduce its effect on the polymer. However, it cannot prevent further degradation of fibers degraded by light or heat. For this reason, protection against all effects of sunlight cannot be provided with UV absorbers.

There are several applications in the literature regarding the subject. One of these, is the document numbered U.S. Ser. No. 10/214,836B1, describes the use of HALS (hindered amine light stabilizer) light stabilizers to prevent degradation of acrylic fiber in the presence of UV light. Where acrylic fiber was prevented from degrading against light by means of the HALS stabilizers used in said application, the same HALS stabilizers were not able to prevent the fiber from degradation against heat.

In the invention of the document numbered JP4243478B2, UV absorber with a triazine structure is used in the modacrylic fiber. Although said UV absorber cannot prevent further degradation of the fibers degraded by light or heat, protection against all the effects of sunlight could not be provided in the present invention.

The invention of the application numbered U.S. Pat. No. 7,694,827B2 is related to the use of metal oxide particles in acrylic fiber to prevent degradation against heat. The mentioned thermal protection is provided for acrylic fiber used in hot gas filters, and there is no information about protection against infrared heating from sunlight in said application.

As a result, due to the aforementioned negativities and deficiencies, there has been a need to make an innovation in the relevant technical field.

The Aim of the Invention The present invention relates to an acrylic and modacrylic fiber stabilized against sunlight that meets the aforementioned requirements, eliminates all the disadvantages and brings some additional advantages.

The main purpose of the invention is to increase the resistance of acrylic fiber containing at least 85% acrylonitrile groups and modacrylic fibers containing at least 40% acrylonitrile groups and at least 40% vinylidene chloride groups against UV light and surface heating caused by sunlight.

The aim of the invention is to increase the resistance of acrylic fiber and modacrylic fibers against IR radiation and UV radiation from sunlight.

The aim of the invention is to protect acrylic and modacrylic fibers against the all effects of sunlight by applying HALS, UV absorber and IR reflective materials together.

The aim of the invention is to prevent color changes and loss of strength that may occur over time in outdoor fabrics produced from acrylic and modacrylic fibers.

Another aim of the invention is to extend the life of outdoor fabrics made from acrylic and modacrylic fiber.

In order to achieve the purposes described above, the invention is an acrylic fiber containing at least 85% acrylonitrile groups or a modacrylic fiber containing at least 40% acrylonitrile groups and at least 40% vinylidene chloride groups, produced for use in outdoor textiles, characterized in that it comprises UV absorbing material, hindered amine light stabilizer (HALS) and IR reflective material to increase the resistance against UV light and surface heating caused by sunlight.

In order to achieve the purposes described above, the invention is the production method of acrylic fiber or modacrylic fiber for use in outdoor textiles, which includes process steps of,
a) polymerizing at least 85% acrylonitrile and vinyl co-monomer or polymerizing at least 40% acrylonitrile, at least 40% vinylidene chloride and vinyl co-monomer,
b) preparing a dope solution by dissolving the obtained polymer in polar aprotic solvents, c) transferring the dope mixture by means of a pump onto the plates called spinnerets, which have holes to define the fiber diameter,
d) giving the dope mixture received out of the plates a filament form in the coagulation bath,
e) washing the filament to remove the excess solvent,
f) transferring the washed filaments to the finishing bath without allowing them to dry and then drying them,
g) crimping and annealing filaments obtained after drying, characterized in that it includes the following process steps to increase the resistance against surface heating and UV light caused by sunlight,
adding a HALS solution, UV absorbing solution and IR reflective dispersion, each prepared in a separate container, into the dope solution mentioned in process step b or
adding the prepared IR reflective dispersion into the dope solution mentioned in process step b,
adding HALS and UV absorbing material prepared by encapsulation in water separately, into the finishing bath before process step f.

The structural and characteristic features and all of the advantages of the invention will be understood more clearly by means of the detailed description given below and therefore evaluation should be made by taking this detailed description into consideration.

Figures to Help Understand the Invention

FIG. 1: Light degradation mechanism of acrylic fiber

FIG. 2: Heat degradation mechanism of acrylic fiber

### DETAILED DESCRIPTION OF THE INVENTION

In this detailed description, an acrylic and modacrylic fiber stabilized against sunlight is described only for a better understanding of the subject and without any limiting effect.

The invention relates to increasing the resistance of acrylic fiber containing at least 85% acrylonitrile groups or modacrylic fibers containing at least 40% acrylonitrile groups and at least 40% vinylidene chloride groups, produced for use in outdoor textiles, against UV light and surface heating caused by sunlight. The feature of the invention is that HALS, UV absorbing and IR reflective materials are applied together.

In the production of acrylic and modacrylic fiber of the invention, 0.1-10% by weight preferably 0.5% HALS, 0.1-10% by weight, preferably 0.5% UV absorbing material and 0.05-5% by weight, preferably 0.25% IR reflective material is used.

The UV absorbing material reduces the exposure of the polymer to UV light by absorbing harmful UV rays from sunlight. In the preferred embodiment of the invention, inorganic and organic compounds are used as UV absorbing material. As the inorganic compound, individual or combinations selected from the group consisting of zinc oxide, cerium oxide, molybdenum oxide, zirconium phosphate and zirconium oxide can be used. As the organic compound, individual or combinations selected from the group consisting of benzophenone, benzotriazole, hydroxyphenyl triazine, oxanilidine and hindered benzoate can be used. UV absorbing materials can be added to the polymer during doping or in the finishing step.

UV absorbing materials consisting of inorganic compounds are insoluble in water and solvents alone. Suspension/dispersion is obtained by mixing UV absorbing materials with solvent and polymer. The average particle size of the used UV absorbing material should be smaller than 300 nm so that it can be added into the dope. If UV absorbing materials with an average particle size greater than 300 nm are used, they are subjected to a grinding process to reduce the particle size.

UV absorbing materials consisting of organic compounds can be used by adding in dope if they are dissolved in in polar aprotic, such as DMAc, DMF, DMSO, NMP, ethylene carbonate, propylene carbonate, gamma-butrolactone, gamma-valerolactan, MEK, acetone and THF in powder form. If these materials are water-soluble or dispersible, they can be applied to the fiber during finishing.

The volatility of UV absorbers dissolved in the solvent is less than 5% at 300° C. In the preferred embodiment of the invention, the pH value of the used UV absorbing materials in %20 of solution is between 4-9.

IR reflective materials prevent thermal degradation caused by surface heating caused by infrared radiation from sunlight. IR reflective materials used in the preferred embodiment of the invention are individuals or combinations selected from the group consisting of rutile titanium dioxide, tourmaline, nepheline syenite, barium sulphate, lithopone, zinc sulfide, aluminum oxide and carbon nanotubes. Suspension/dispersion is obtained by mixing IR reflective materials with solvent and polymer. The average particle size of the used IR reflective material should be smaller than 300 nm so that it can be added into the dope. If IR reflective materials with an average particle size greater than 300 nm are used, they are subjected to a grinding process to reduce the particle size. The pH value of dispersion obtained with IR materials should be between 5-8.

HALS (hindered amine light stabilizer) ensures that the primary radicals formed by harmful UV radiation from sunlight are trapped in polymers and converted into harmless compounds. The structure of HALS used in the preferred embodiment of the invention is as shown in formula 1 or formula 2.

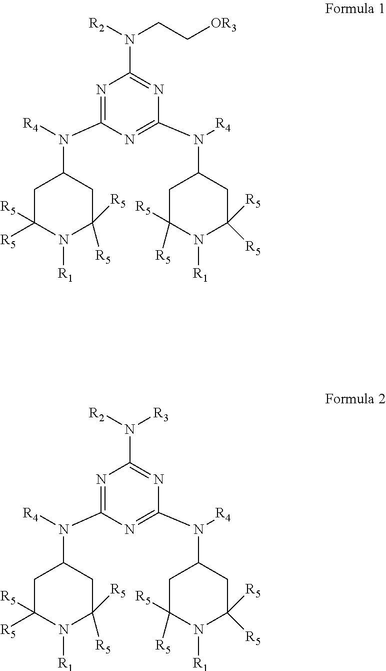

Each R1 is selected from the group consisting of alkyl, cycloalkyl, hydroxyalkyl, cyclohydroxyalkyl, alkenyl, cycloalkenyl, cyclohydroxyalkenyl, benzyl and hydroxybenzyldene.

Each R2, R3, R4 and R5 is selected from the group consisting of hydrogen, methyl, hydroxymethyl, alkyl, cycloalkyl, hydroxyalkyl, cyclohydroxyalkyl, alkenyl, cycloalkenyl, cyclohydroxyalkenyl, benzyl and hydroxybenzyldene.

HALS encapsulated in powder form or in water can be used to obtain acrylic or modacrylic fiber according to the invention. The solution can be obtained by dissolving in the HALS solvent in powder form. The pH value of the 20% solution of the used HALS is between 4-9. In powder form, the solubility of HALS in water is less than 1%. In the preferred embodiment of the invention, polar aprotic solvents such as, DMAc, DMF, DMSO, NMP, ethylene carbonate, propylene carbonate, gamma-butrolactone, gamma-valerolactan, MEK, acetone, THF, etc. can be used as solvent.

HALS encapsulated in water is applied on the fiber by finishing. The pH value of the 10% aqueous solution of the encapsulated HALS is between 4-9.

The molecular weight of HALS encapsulated both in powder form and in water can be 500-1500 g/mol or 2000-5000 g/mol.

There are 3 types of electromagnetic radiation in sunlight reaching the earth: ultraviolet, visible and infrared. UV radiation is the radiation that has the lowest wavelengths and highest energy. All organic molecules and polymers have UV permeability due to the covalent bonds in their structures. The wavelength of a polymer with the highest permeability is the energy that will destroy its structure the most. The energy emitted by this radiation causes the breaking of bonds such as carbon-nitrogen single covalent bond, oxygen-oxygen single covalent bond, carbon-carbon single covalent bond, carbon-hydrogen single covalent bond, carbon-chlorine single covalent bond in polymer chains, and the formation of radicals. Since radicals are very reactive molecules, they react in a short time with intact bonds and oxygen in the air, causing the polymer chains to degrade. This degradation is called photo-oxidation. Since this degradation increases with an exponential rate, there is a rapid color change and loss of strength in polymers and their lifetime decreases. Infrared wavelengths coming from sunlight enable the polymers to heat up. This heating causes thermal oxidation in polymers over time. In some polymers, the mechanisms of thermal oxidation and photo-oxidation are the same, but these two mechanisms are different in acrylic and modacrylic fibers.

The wavelength at which fibers obtained from polyacrylonitrile copolymers and consisting of at least 85% acrylonitrile by weight have the highest permeability is 300 nanometers. In the invention, the UV absorber is used to absorb the wavelengths to which the fiber is most sensitive and render it harmless, but the UV absorber alone is not sufficient to provide said protection. Radicals that may occur in prolonged exposure to sunlight must be rendered harmless. HALS molecules stop photo-oxidation by reacting with radicals formed by means of piperidine groups in its structure. The combination of UV absorber and HALS molecules provides the highest protection to the fiber against photo-oxidation, but this protection does not affect degradation induced by thermal oxidation. IR reflective materials prevent heating on the surface of the fibers by reflecting the infrared wavelengths coming from sunlight. With the combination of UV absorber, HALS and IR reflective materials, acrylic and modacrylic fibers have a high degree of effectiveness against degradation induced by photo-oxidation and thermal oxidation in the presence of sunlight.

A method of obtaining acrylic fiber with increased resistance against surface heating and UV light caused by sunlight;
At least 85% acrylonitrile and vinyl co-monomer is polymerized,
A dope solution is prepared by dissolving the obtained polymer in polar aprotic solvents,
HALS solution, UV absorbing solution and IR reflective dispersion are prepared in a separate container,
The prepared solutions and dispersion are added into the dope solution regardless of the order.
The dope mixture is transferred to the plates called spinnerets, which have holes to define the fiber diameter, by means of a pump and the dope mixture coming out of the plates is made filament form in the coagulation bath (in a mixture of water-solvent),
Then, is the mixture is washed to remove excess solvent on said filament,
The washed filaments are transferred to the finishing bath without allowing them to dry, and then they are dried,
The filaments obtained after drying are crimped to obtain better yarn,
The crimped fiber is annealed and the final product is obtained.

The co-monomers that can be used in the preferred embodiment of the invention are vinyl acetate, methyl acrylate, methyl methacrylate, styrene, vinyl pyrrilidone, vinyl alcohol, acrylic acid, acrylamide, sodium methyl allyl sulphonate, sodium styrene sulphonate, itaconic acid, glycidine methacrylate, vinyl chloride, vinylidene chloride, vinyl fluoride, vinylidene fluoride, vinyl benzoate, vinyl butyrate or butyl vinyl ether.

A method of obtaining modacrylic fiber with increased resistance against surface heating and UV light caused by sunlight;
At least 40% acrylonitrile, at least 40% vinylidine chloride and vinyl co-monomer is polymerized,
A dope solution is prepared by dissolving the obtained polymer in polar aprotic solvents,
HALS solution, UV absorbing solution and IR reflective dispersion are prepared in a separate container,
The prepared solutions and dispersion are added into the dope solution regardless of the order.
The dope mixture is transferred to the plates called spinnerets, which have holes to define the fiber diameter, by means of a pump and the dope mixture coming out of the plates is made filament form in the coagulation bath (in a mixture of water-solvent),
Then, is the mixture washed to remove excess solvent on said filament,
The washed filaments are transferred to the finishing bath without allowing them to dry, then they are dried,
The filaments obtained after drying are crimped to obtain better yarn,
The crimped fiber is annealed and the final product is obtained.

The vinyl co-monomers that can be used in the preferred embodiment of the invention are vinyl acetate, methyl acrylate, methyl methacrylate, styrene, vinyl pyrrilidone, vinyl alcohol, acrylic acid, acrylamide, sodium methyl allyl sulphonate, sodium styrene sulphonate, itaconic acid, glycidine methacrylate, vinyl chloride, vinyl fluoride, vinylidene fluoride, vinyl benzoate, vinyl butyrate or butyl vinyl ether.

Another method to be applied in order to obtain an acrylic fiber with increased resistance against surface heating and UV light caused by sunlight;
At least 85% acrylonitrile and vinyl co-monomer is polymerized,
A dope solution is prepared by dissolving the obtained polymer in polar aprotic solvents,
The IR reflective dispersion is prepared in a separate container and added into the dope solution,
The dope mixture is transferred to the plates called spinnerets, which have holes to define the fiber diameter, by means of a pump and the dope mixture coming out of the plates is made filament form in the coagulation bath (in a mixture of water-solvent),
Then, is the mixture is washed to remove excess solvent on said filament,
HALS and UV absorbing material that are prepared by being encapsulated in water separately, are added into the finishing bath,
The washed filaments are transferred to said finishing bath without allowing them to dry, and then they are dried,
The filaments obtained after drying are crimped to obtain better yarn,
The crimped fiber is annealed and the final product is obtained.

Another method to be applied in order to obtain a modacrylic fiber with increased resistance against surface heating and UV light caused by sunlight;
At least 40% acrylonitrile, at least 40% vinylidene chloride and vinyl co-monomer is polymerized,
A dope solution is prepared by dissolving the obtained polymer in polar aprotic solvents,
The IR reflective dispersion is prepared in a separate container and added into the dope solution,
The dope mixture is transferred to the plates called spinnerets, which have holes to define the fiber diameter, by means of a pump and the dope mixture coming out of the plates is made filament form in the coagulation bath (in a mixture of water-solvent),
Then, the mixture is washed to remove excess solvent on said filament,
HALS and UV absorbing material prepared by encapsulating in water separately are added into the finishing bath,
The washed filaments are transferred to said finishing bath without allowing them to dry, and then they are dried,
The filaments obtained after drying are crimped to obtain better yarn,
The crimped fiber is annealed and the final product is obtained.

Another subject of the invention is acrylic fiber or modacrylic fiber obtained by the production methods mentioned above.

In the preferred embodiment of the invention, outdoor textiles are awning fabrics, marine fabrics, furnishing fabrics used in outdoor furniture, fabrics used in sunshades and fabrics used in sails of ships.

1. An acrylic fiber containing at least 85% acrylonitrile groups or a modacrylic fiber containing at least 40% acrylonitrile groups and at least 40% vinylidene chloride groups, produced for use in outdoor textiles, the acrylic fiber further comprising UV absorbing material, hindered amine light stabilizer (HALS) and IR reflective material to increase the resistance against UV light and surface heating caused by sunlight.

2. The acrylic fiber or modacrylic fiber of claim 1, comprising UV absorbing material at a rate of 0.1-10%.

3. The acrylic fiber or modacrylic fiber of claim 1, comprising HALS at a rate of 0.1-10%.

4. The acrylic fiber or modacrylic fiber of claim 1, comprising IR reflective material at a rate of 0.05-5%.

5. The acrylic fiber or modacrylic fiber of claim 1, wherein said UV absorbing material is a single material or combinations selected from the group consisting of zinc oxide, cerium oxide, molybdenum oxide, zirconium phosphate and zirconium oxide.

6. The acrylic fiber or modacrylic fiber of claim 1, wherein said UV absorbing material is a single material or combinations selected from the group consisting of benzophenone, benzotriazole, hydroxyphenyl triazine, oxanilidine and hindered benzoate.

7. The acrylic fiber or modacrylic fiber of claim 1, wherein the molecular structure of said hindered amine light stabilizer is formula 1 or formula 2 shown below. 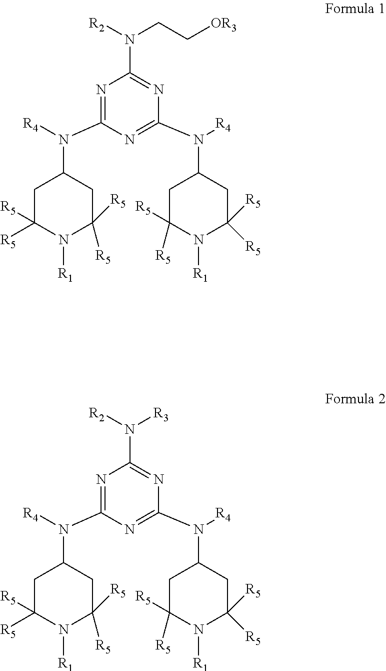
Each R1 is selected from the group consisting of alkyl, cycloalkyl, hydroxyalkyl, cyclohydroxyalkyl, alkenyl, cycloalkenyl, cyclohydroxyalkenyl, benzyl and hydroxybenzyldene. Each R2, R3, R4 and R5 are selected from the group consisting of hydrogen, methyl, hydroxymethyl, alkyl, cycloalkyl, hydroxyalkyl, cyclohydroxyalkyl, alkenyl, cycloalkenyl, cyclohydroxyalkenyl, benzyl and hydroxybenzyldene.

8. The acrylic fiber or a modacrylic fiber of claim 1, wherein the molecular weight of said HALS is 500-1500 g/mol or 2000-5000 g/mol.

9. The acrylic fiber or modacrylic fiber of claim 1, wherein said IR reflective materials are individuals or combinations selected from the group consisting of rutile titanium dioxide, tourmaline, nepheline syenite, barium sulphate, lithopone, zinc sulfide, aluminum oxide and carbon nanotubes.

10. Production method of acrylic fiber or modacrylic fiber to be used in outdoor textiles comprising the steps of:
a) polymerizing at least 85% acrylonitrile and vinyl co-monomer or polymerizing at least 40% acrylonitrile, at least 40% vinylidene chloride and vinyl co-monomer,
b) preparing a dope solution by dissolving the obtained polymer in polar aprotic solvents,
c) transferring the dope mixture by means of a pump onto the plates called spinnerets, which have holes to define the fiber diameter,
d) giving the dope mixture received out of the plates a filament form in the coagulation bath,
e) washing the filament to remove the excess solvent,
f) transferring the washed filaments to the finishing bath without allowing them to dry and then drying them,
g) crimping and annealing filaments obtained after drying,
characterized in that it includes the following process steps to increase the resistance against surface heating and UV light caused by sunlight,
adding a HALS solution, UV absorbing solution and IR reflective dispersion, each prepared in a separate container, into the dope solution mentioned in process step b or
adding the prepared IR reflective dispersion into the dope solution mentioned in process step b,
adding HALS and UV absorbing material prepared by encapsulation in water separately, into the finishing bath before process step f.

11. The production method of claim 10, comprising UV absorbing material at a rate of 0.1-10%.

12. The production method of claim 10, comprising HALS at a rate of 0.1-10%.

13. The production method to of claim 10, comprising IR reflective material at a rate of 0.05-5%.

14. The production method of claim 10, wherein said UV absorbing material is a single material or combinations selected from the group consisting of zinc oxide, cerium oxide, molybdenum oxide, zirconium phosphate and zirconium oxide.

15. The production method of claim 10, wherein said UV absorbing material is a single material or combinations selected from the group consisting of benzophenone, benzotriazole, hydroxyphenyl triazine, oxanilidine and hindered benzoate.

16. The production method of claim 10, wherein the pH value of said UV absorbing materials in %20 of solution is between 4-9.

17. The production method of claim 10, wherein the molecular structure of said hindered amine light stabilizer is formula 1 or formula 2 shown below. 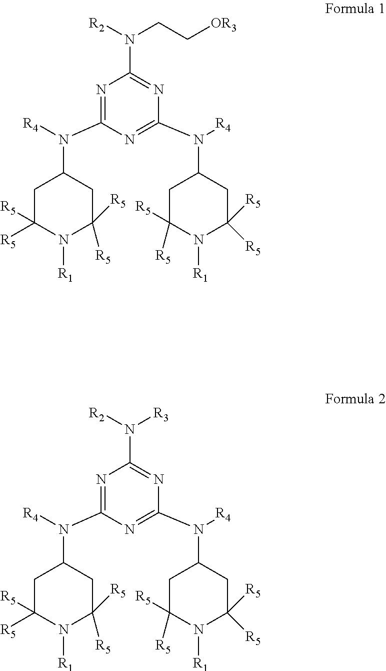
Each R1 is selected from the group consisting of alkyl, cycloalkyl, hydroxyalkyl, cyclohydroxyalkyl, alkenyl, cycloalkenyl, cyclohydroxyalkenyl, benzyl and hydroxybenzyldene. Each R2, R3, R4 and R5 are selected from the group consisting of hydrogen, methyl, hydroxymethyl, alkyl, cycloalkyl, hydroxyalkyl, cyclohydroxyalkyl, alkenyl, cycloalkenyl, cyclohydroxyalkenyl, benzyl and hydroxybenzyldene.

18. The production method according to claim 10, wherein the pH value of the 10% aqueous solution of said HALS is between 4-9.

19. The production method according to claim 10, wherein the molecular weight of said HALS is 500-1500 g/mol or 2000-5000 g/mol.

20. The production method of claim 10, wherein said IR reflective material is a single material or combinations selected from the group consisting of rutile titanium dioxide, tourmaline, nepheline syenite, barium sulphate, lithopone, zinc sulfide, aluminum oxide and carbon nanotubes.

21. The production method of claim 10, wherein the pH value of the dispersion obtained with said IR materials is between 5-8.

22. The production method of claim 10, wherein vinyl co-monomers mentioned in process step a, are vinyl acetate, methyl acrylate, methyl methacrylate, styrene, vinyl pyrrilidone, vinyl alcohol, acrylic acid, acrylamide, sodium methyl allyl sulphonate, sodium styrene sulphonate, itaconic acid, glycidine methacrylate, vinyl chloride, vinyl fluoride, vinylidene fluoride, vinyl benzoate, vinyl butyrate or butyl vinyl ether.
